(19) United States
(12) Patent Application Publication
(10) Pub. No.: US 2019/0199979 A1
(43) Pub. Date: Jun. 27, 2019

(54) IMAGE PROCESSING SYSTEM, IMAGE PROCESSING METHOD, IMAGE PROCESSING DEVICE, RECORDING MEDIUM AND PORTABLE APPARATUS

(71) Applicant: CASIO COMPUTER CO., LTD., Tokyo (JP)

(72) Inventors: Hideo ABE, Tokorozawa-shi (JP); Ryuji SHINGYOJI, Tokyo (JP)

(73) Assignee: CASIO COMPUTER CO., LTD., Tokyo (JP)

(21) Appl. No.: 16/228,354

(22) Filed: Dec. 20, 2018

(30) Foreign Application Priority Data
Dec. 25, 2017 (JP) 2017-247798

(51) Int. Cl. H04N 7/18; H04N 5/247; H04N 1/00

(52) U.S. Cl. CPC H04N 7/188; H04N 5/247; H04N 1/00114; H04N 1/00244; H04N 1/00214; H04N 7/181

(57) ABSTRACT

In a photographing system, a network camera transmits image information pertaining to an image captured by the network camera, a beacon transmits a beacon ID, a portable apparatus receives the beacon ID, generates tracking data which corresponds to the beacon ID on the basis of a reception status of the beacon ID and transmits the generated tracking data and a server receives the image information transmitted from the network camera and the tracking data transmitted from the portable apparatus and specifies images of parts relating to enter and leave times of an object from images in the image information on the basis of the image information and the tracking data.

The present application claims priority based on Japanese Patent Application No. 2017-247798 filed on Dec. 25, 2017. The contents of which are incorporated herein by reference in their entirety.

### BACKGROUND OF THE INVENTION

### 1. Field of the Invention

The present invention relates to an image processing system, an image processing method, an image processing device, a recording medium and a portable apparatus.

### 2. Description of the Related Art

As described in Japanese Patent Application Laid-Open No. 2014-225831, a photographing system which is configured to photograph a moving object by accurately catching appearance of the moving object when automatically photographing the moving object at a predetermined position has been proposed so far.

### SUMMARY OF THE INVENTION

According to one embodiment of the present invention, there is provided an image processing system including a portable apparatus that an object possesses, an imaging device which is installed in a predetermined area, a transmission device which is installed in the predetermined area and transmits a transmission device ID which identifies the transmission device itself, an image processing device which processes an image which is captured by the imaging device, in which a PROCESSOR of the imaging device transmits image information pertaining to the image which is captured by the imaging device, a PROCESSOR of the transmission device transmits the transmission device ID, a PROCESSOR of the portable apparatus receives the transmitted transmission device ID, generates information which corresponds to the transmission device ID on the basis of a reception status of the transmission device ID and transmits the generated information which corresponds to the transmission device ID or the transmission device ID, and a PROCESSOR of the image processing device receives the transmitted image information and the transmitted information which corresponds to the transmission device ID or the transmission device ID, and specifies images of parts relating to times that the object enters and leaves the area where the transmission device is installed from images in the image information on the basis of the received image information and the received information which corresponds to the transmission device ID or the transmission device ID.

According to one embodiment of the present invention, there is also provided an image processing method by an image processing system which includes a portable apparatus that an object possesses, an imaging device which is installed in a predetermined area, a transmission device which is installed in the predetermined area and transmits a transmission device ID which identifies the transmission device itself, and an image processing device which processes an image which is captured by the imaging device, including the step of transmitting, by the imaging device, image information pertaining to the image which is captured by the imaging device, the step of transmitting the transmission device ID by the transmission device, the step of receiving the transmission device ID which is transmitted from the transmission device, generating information which corresponds to the transmission device ID on the basis of a reception status of the transmission device ID and transmitting the generated information which corresponds to the transmission device ID or the transmission device ID by the portable apparatus, and the step of receiving the image information which is transmitted from the imaging device and the information which is transmitted from the portable apparatus and corresponds to the transmission device ID or the transmission device ID and specifying images of parts relating to times that the object enters and leaves the area where the transmission device is installed from images in the image information on the basis of the image information and the information which corresponds to the transmission device ID or the transmission device ID.

According to one embodiment of the present invention, there is also provided an image processing device which processes an image which is captured by an imaging device, in which a PROCESSOR of the image processing device receives image information of the image which is captured by the imaging device which is installed in a predetermined area, receives information which is generated by a portable apparatus that an object possesses on the basis of a reception status of a transmission device ID of a transmission device which is installed in the predetermined area and corresponds to the transmission device ID or the transmission device ID and specifies images of parts relating to times that the object enters and leaves the area where the transmission device is installed from images in the image information on the basis of the received image information and the information which corresponds to the transmission device ID or the transmission device ID.

According to one embodiment of the present invention, there is also provided a recording medium in which a computer readable program is recorded, making a computer implement a first reception function of receiving image information of an image which is captured by the imaging device which is installed in a predetermined area, a second reception function of receiving information which is generated by a portable apparatus that an object possesses on the basis of a reception status of a transmission device ID of a transmission device which is installed in the predetermined area and corresponds to the transmission device ID or the transmission device ID and an image specification function of specifying images of parts relating to times that the object enters and leaves the area where the transmission device is installed from images in the image information on the basis of the image information which is received by the first reception function and the information which is received by the second reception function and corresponds to the transmission device ID or the transmission device ID.

According to one embodiment of the present invention, there is also provided a portable apparatus that an object possesses, in which a PROCESSOR of the portable apparatus receives a transmission device ID which is transmitted from a transmission device which is installed in a predetermined area and transmits the transmission device ID for identifying the transmission device itself, generates information which corresponds to the transmission device ID on the basis of a reception status of the transmission device ID, transmits the generated information or the transmission device ID to an image processing device and acquires images of parts relating to times that the object enters and leaves the predetermined area which is specified by the image processing device on the basis of an image which is captured by an imaging device which is installed in the predetermined area and the information which corresponds to the transmission device ID or the transmission device ID.

### BRIEF DESCRIPTION OF THE SEVERAL VIEWS OF THE DRAWING

FIG. 1 is a diagram illustrating one example of a schematic configuration of a photographing system.

FIG. 2 is a block diagram illustrating one example of a functional configuration of a server.

FIG. 3 is a block diagram illustrating one example of a functional configuration of a portable apparatus.

FIG. 4 is a block diagram illustrating one example of a functional configuration of a network camera.

FIG. 5 is an imaginary diagram illustrating one example of a photographing service which utilizes the photographing system.

FIG. 6 is a diagram illustrating one example of screens of the portable apparatus which displays conversations exchanged with a camerabot in a chat for a personal.

FIG. 7 is a diagram illustrating one example of screens of the portable apparatus which displays conversations exchanged with the camerabot in a chat for a group.

FIG. 8A is a diagram illustrating one example of a logfile for an individual user.

FIG. 8B is a diagram illustrating one example of a logfile for a group.

FIG. 9 is a flowchart illustrating one example of image edition processing.

### DETAILED DESCRIPTION OF THE INVENTION

In the following, specific aspects of the present invention will be described by using the drawings. However, the scope of the present invention is not limited to an illustrated example.

### <Configuration of Photographing System>

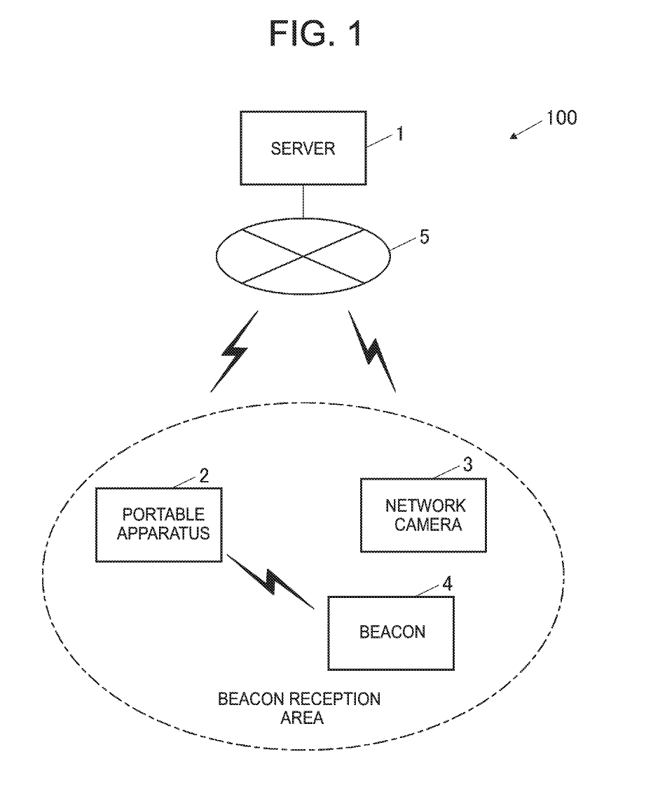

First, a schematic configuration of a photographing system (an image processing system) 100 will be described with reference to FIG. 1. FIG. 1 is a diagram illustrating one example of the schematic configuration of the photographing system 100.

As illustrated in FIG. 1, the photographing system 100 includes a server (an image processing device) 1, one or a plurality of potable apparatus(s) 2, one or a plurality of network camera(s) (an imaging device/devices)) 3 and one or a plurality of beacon(s) (a transmission device/devices, a transmission device side transmission section/sections) 4. The server 1 and the portable apparatus(s) 2, and the server 1 and the network camera(s) 3 are respectively connected with each other/one another to be information-communicable via the Internet 5. In addition, each beacon 4 transmits a beacon ID (a beacon signal) for identifying the beacon 4 itself at any time and each portable apparatus 2 is configured to receive the beacon ID of the beacon 4 when the portable apparatus 2 enters a reception area of the beacon 4.

The server 1 is a server which provides a user with a photographing service by the photographing system 100 and stores and manages tracking data (which will be described later) which is transmitted from the portable apparatus 2, image information which is transmitted from the network camera 3 and so forth. In addition, the server 1 performs various kinds of data processing (for example, user registration (group registration), image addition, image publication and so forth) by executing various programs.

The portable apparatus 2 is, for example, a smartphone, a tablet PC, a cell phone, a PDA (Person Digital Assistant) and so forth that the user possesses when moving. The portable apparatus 2 accepts an input operation of the user, transmits information which is based on the input operation concerned to the server 1 and displays information which is transmitted from the server 1 and received by the portable apparatus 2 itself.

The network camera 3 is a network camera adapted to photograph a predetermined area where the photographing service by the photographing system 100 is performed and transmits the image information (including recording time information) of photographed images to the server 1 at any time. The predetermined area where the photographing service is performed may be either one place or a plurality of places.

The beacon 4 is installed in the predetermined area where the photographing service by the photographing system 100 is performed and transmits the beacon ID at any time. That is, the beacon 4 is configured to be installed by the number according to the number of the predetermined areas where the photographing service is performed.

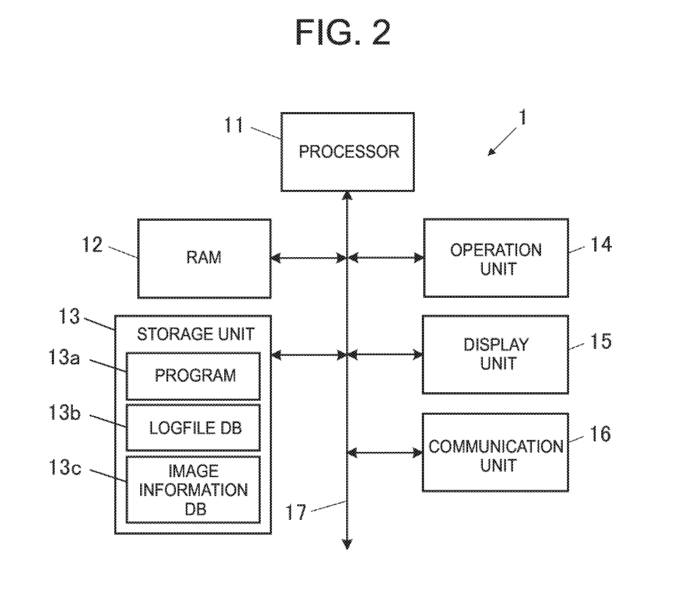

FIG. 2 is a block diagram illustrating one example of a functional configuration of the server 1.

As illustrated in FIG. 2, the server 1 includes a PROCESSOR 11, a RAM (Random Access Memory) 12, a storage unit 13, an operation unit 14, a display unit 15 and a communication unit (an image processing device side reception section, an image processing device side transmission section, a first reception section, a second reception section) 16. In addition, the respective units of the server 1 are connected with one another via a bus 17.

The PROCESSOR 11 controls the respective units of the server 1. The PROCESSOR 11 reads out a designated program in system programs and application programs which are stored in the storage unit 13, evolves the read-out program in a work area of the RAM 12 and executes various processes in accordance with the program concerned.

The RAM 12 is, for example, a volatile memory and has the work area where the various programs and various kinds of data which are read out by the processor 11 are temporarily stored.

The storage unit 13 is configured by, for example, an HDD (Hard Disk Drive), an SSD (Solid State Drive) and so forth and is a data and program writable/readable storage unit. In addition, the storage unit 13 stores a program 13a, a logfile DB 13b, an image information DB 13c and so forth.

The program 13a includes the above-described various system programs and application programs to be executed by the PROCESSOR 11.

The logfile DB (a storage unit) 13b is a database in which a logfile (which will be described later) which is prepared targeting on a user or a group who completes registration for utilization of the photographing service by the photographing system 100.

The image information DB 13c is a database in which image information which is transmitted from the network camera 3 via the Internet 5 is registered.

The operation unit 14 has, for example, a key input section such as a keyboard and so forth and a pointing device such as a mouse and so forth. In addition, the operation unit 14 accepts a key input and a position input and outputs operation information on the key input and the position input to the PROCESSOR 11.

The display unit 15 is configured by, for example, an LCD (Liquid Crystal Display), an organic EL (Electro Luminescence) display and so forth. In addition, various screens are displayed on the display unit 15 in accordance with an instruction of a display signal which is input from the PROCESSOR 11.

The communication unit 16 is configured by, for example, a network card and so forth. In addition, the communication unit 16 is connected to the Internet 5 in a communicable state and performs communication with equipment (for example, the portable apparatus 2, the network camera 3 and so forth) on the Internet 5.

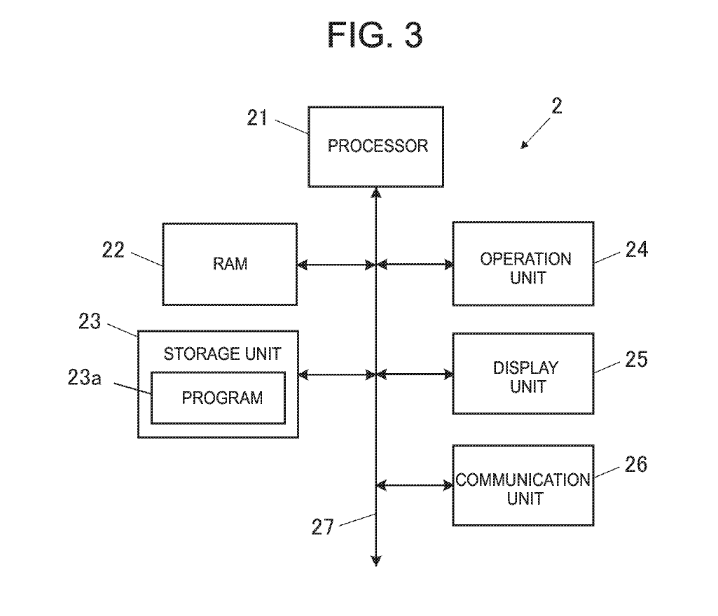

FIG. 3 is a block diagram illustrating one example of a functional configuration of the portable apparatus 2.

As illustrated in FIG. 3, the portable apparatus 2 includes a PROCESSOR 21, a RAM 22, a storage unit 23, an operation unit 24, a display unit 25 and a communication unit (a portable apparatus side reception section, a portable apparatus side transmission section, an acquisition section) 26. In addition, the respective units of the portable apparatus 2 are connected with one another via a bus 27.

The PROCESSOR 21 controls the respective units of the portable apparatus 2. The PROCESSOR 21 reads out a designated program in system programs and application programs which are stored in the storage unit 23, evolves the read-out program in a work area of the RAM 22 and executes various processes in accordance with the program concerned. In that case, the PROCESSOR 21 operates to store results of execution of various processes in the RAM 22 and to display the results of execution of various processes on the display unit 25 as necessary.

The RAM 22 is, for example, a volatile memory and has a work area where various programs and various kinds of data which are read out by the processor 21 are temporarily stored.

The storage unit 23 is configured by, for example, the HDD, the SSD and so forth and is a data and program writable/readable storage unit. In addition, the storage unit 23 stores a program 23a. The program 23a includes the above-described various system programs and application programs to be executed by the PROCESSOR 21.

The operation unit 24 includes various kinds of function keys, accepts an input by depressing each key by the user and outputs operation information on the input by key depression to the PROCESSOR 21. In addition, the operation unit 24 has a touch panel and so forth that transparent electrodes are installed in the form of a grid shape so as to cover a surface of the display unit 25, detects a position which is depressed with a finger, a touch pen and so forth and outputs position information on the depressed position to the PROCESSOR 21 as operation information.

The display unit 25 is configured by, for example, the LCD and so forth. Various screens are displayed on the display unit 25 in accordance with an instruction of a display signal which is input from the PROCESSOR 21.

The communication unit 26 is wirelessly connected to the Internet 5 via a base station or an access point and performs communication with the server 1 which is connected to the Internet 5. In addition, the communication unit 26 receives the beacon ID which is transmitted from the beacon 4 by a wireless communication system such as, for example, Wi-Fi and so forth.

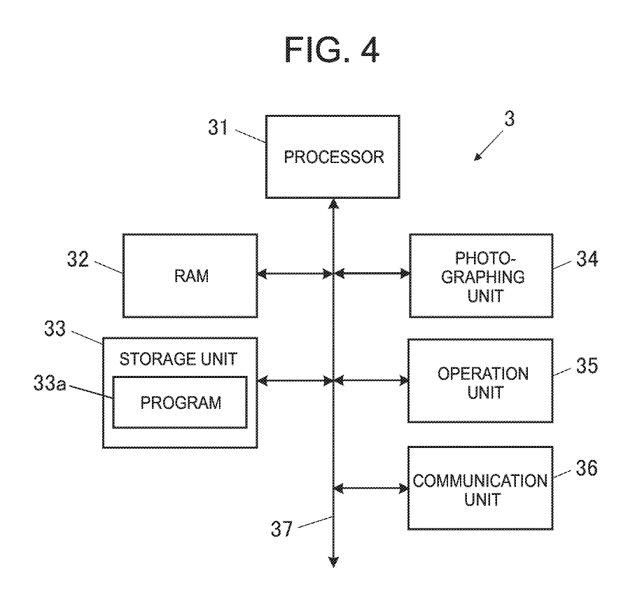

FIG. 4 is a block diagram illustrating one example of a functional configuration of the network camera 3.

As illustrated in FIG. 4, the network camera 3 includes a PROCESSOR 31, a RAM 32, a storage unit 33, a photographing unit 34, an operation unit 35 and a communication unit (an imaging device side transmission section) 36. In addition, the respective units of the network camera 3 are connected with one another via a bus 37.

The PROCESSOR 31 controls the respective units of the network camera 3. The PROCESSOR 31 reads out a designated program in various system programs and application programs which are stored in the storage unit 33, evolves the read-out program in a work area of the RAM 32 and executes various processes in accordance with the program concerned.

The RAM 32 is, for example, the volatile memory and has the work area where the various programs and various kinds of data which are read out by the PROCESSOR 31 are temporarily stored.

The storage unit 33 is configured by, for example, the HDD, the SSD and so forth and is a data and program writable/readable storage unit. In addition, the storage unit 33 stores a program 33a. The program 33a includes the above-described various system programs and application programs to be executed by the PROCESSOR 31.

The photographing unit 34 photographs a user who becomes the object and generates a photographed image.

Although illustration is omitted, the photographing unit 34 includes a camera which includes an optical system and an imaging element and a photographing control section which controls the camera. The imaging element is an image sensor such as, for example, a CCD (Charge Coupled Device), a CMOS (Complementary Metal Oxide Semiconductor) and so forth. Then, the imaging element converts an optical image which passes through the optical system into a two-dimensional image signal.

The operation unit 35 includes various function keys, accepts an input by depressing each key and outputs operation information on the input by key depression to the PROCESSOR 31.

The communication unit 36 is wirelessly connected to the Internet 5 via the base station or the access point and transmits image information on the image which is captured (photographed) by the photographing unit 34 to the server 1 which is connected to the Internet 5 at any time. Here, it is assumed that when the image information is transmitted to the server 1, the beacon ID of the beacon 4 which is installed in a photographing area of the network camera 3 which captures the image of the image information is transmitted in correspondence with the image information. Thereby, the server 1 is configured to be able to identify that the image in the received image information is an image which is photographed in which area.

### <Photographing Service by Photographing System>

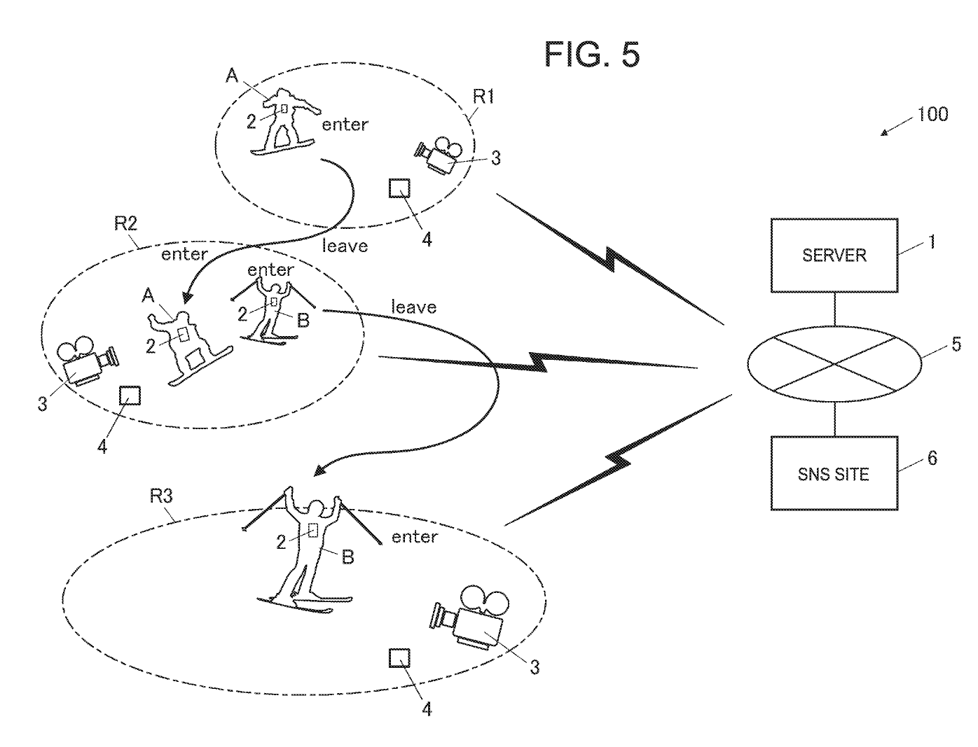

Next, details of the photographing service utilizing the photographing system 100 will be described with reference to FIG. 5 to FIG. 7.

FIG. 5 is an imaginary diagram illustrating one example of the photographing service using the photographing system 100.

As illustrated in FIG. 5, the network camera 3 and the beacon 4 are respectively installed in each of a plurality of areas (for example, a first area R1 to a third area R3) along a sliding course of a skiing ground. The portable apparatus 2 that the user possesses generates tracking data on the basis of the beacon ID received from each beacon 4 and transmits the generated tracking data to the server 1. The server 1 is configured to be able to specify a time that the user enters each area and a time that the user leaves each area on the basis of the tracking data and specifies images of parts relating to the user from images photographed by the respective network cameras 3. Then, the server 1 is configured to be able to cut out the specified images, to combine the cut-out images in time series into one moving image and to provide the user concerned with the moving image.

In a case of receiving provision of the photographing service using the photographing system 100, the user gains access to a predetermined SNS (Social Network Service) site 6 from the portable apparatus 2 that the user possesses via the Internet 5. Then, the user starts a chat function in the SNS site 6 and makes registration of a camerabot as a conversation partner (friend registration) and thereby the photographing service (a personal photographing service) targeting on the user is started. Here, the camerabot is a robot which is in charge of acceptance of the photographing service and so forth and is the one which personifies an exclusive photographer. Then, the photographing system 100 is configured in such a manner that when the photographing service is started, a user ID for identifying the user who made registration of the camerabot is transmitted to the server 1 via the SNS site 6 and a logfile which targets on the user is prepared in the server 1.

As the photographing service, there exists a group photographing service in addition to the personal photographing service. In order to start the group photographing service, the camerabot is registered in a group chat which targets on a group which intends to receive this service and thereby the photographing service (the group photographing service) which targets on respective members of the group is started. Then, the photographing system 100 is configured in such a manner that when the group photographing service is started, user IDs for identifying the respective members are transmitted to the server 1 via the SNS site 6 and a logfile which targets on the group is prepared in the server 1.

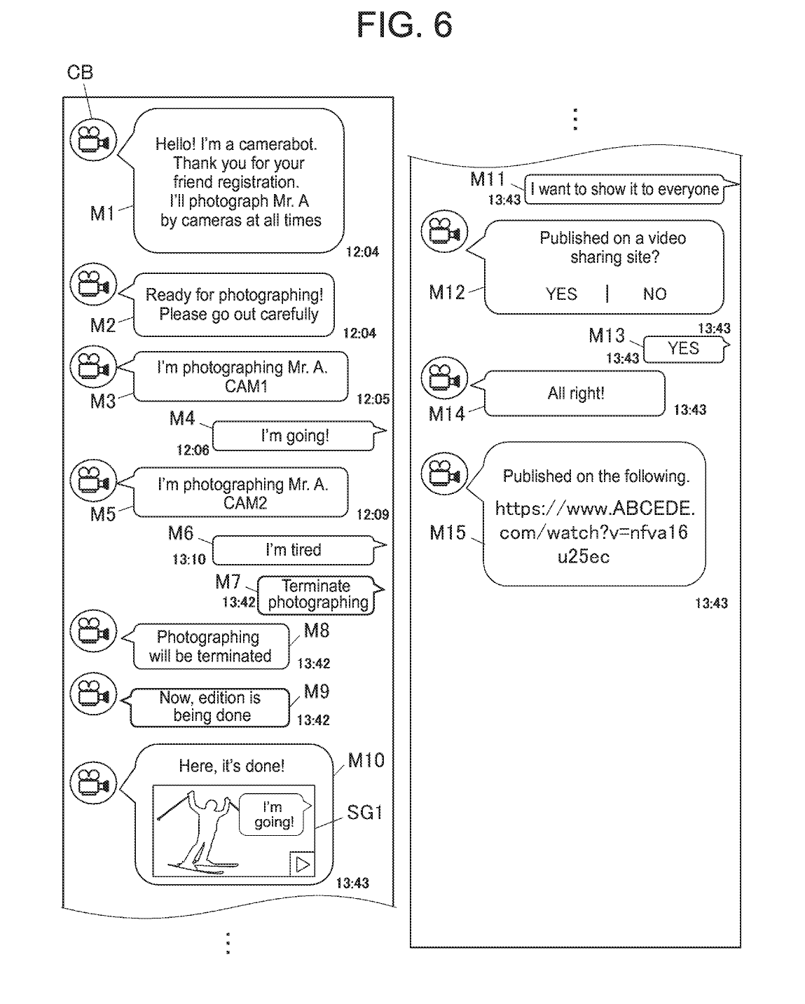

FIG. 6 is a diagram illustrating one example of a flow of conversations exchanged with the camerabot in the personal chat. As illustrated in FIG. 6, for example, when a user A who intends to receive the personal photographing service starts the chat function in the SNS site 6 via the portable apparatus 2 and makes registration of a camerabot CB as the conversation partner, a user ID (for example, “001”) for identifying the user A is transmitted to the server 1 and the server 1 performs control in such a manner that a message M1 of such a content that “Hello! I'm a camerabot. Thank you for your friend registration. I'll photograph Mr. A by cameras at all times” issued from the camerabot CB is displayed on the display unit 25 of the portable apparatus 2 that the user A possesses. Then, when a logfile for the user A is prepared in the server 1, the server 1 performs control in such a manner that a message M2 of such a content that “Ready for photographing! Please go out carefully” issued from the camerabot CB is displayed on the display unit 25 of the portable apparatus 2 that the user A possesses.

Then, as illustrated in FIG. 5, when the user A starts sliding and enters the first area R1, the portable apparatus 2 that the user A possesses receives a beacon ID (=Beacon1) from the beacon 4 which is installed in the first area R1 via the communication unit 26. Then, the portable apparatus 2 transmits tracking data which includes a beacon ID reception time, the beacon ID, the user ID for identifying the user A and an enter flag (enter) to the server 1 via the communication unit 26. Then, when receiving the tracking data via the communication unit 16, the server 1 stores the tracking data into the logfile for the user A in the logfile DB 13b. In addition, the server 1 detects that the enter flag is included in the tracking data and thereby performs control in such a manner that a message M3 of such a content that “I'm photographing Mr. A (CAM1)” issued from the camerabot CB is displayed on the display unit 25 as illustrated in FIG. 6. Here, “CAM1” in the message M3 means the network camera 3 which is installed in the first area R1.

Next, as illustrated in FIG. 6, when a message M4 of such a content that “I'm going!” issued from the user A is displayed on the display unit 25 on the basis of the operation of the portable apparatus 2 by the user A, the message M4 is transmitted to the server 1 and the server 1 stores the message M4 in correspondence with a message M4 transmission time into the logfile for the user A.

Next, as illustrated in FIG. 5, when the user A leaves the first area R1 and reception of the beacon ID (=Beacon1) is interrupted for a definite period of time, the portable apparatus 2 transmits tracking data which includes a time that reception of the beacon ID was interrupted, the beacon ID, the user ID for identifying the user A and a leave flag (leave) to the server 1 via the communication unit 26. Then, when receiving this tracking data via the communication unit 16, the server 1 stores the tracking data into the logfile for the user A.

Next, as illustrated in FIG. 5, when the user A enters the second area R2, the portable apparatus 2 that the user A possesses receives a beacon ID (=Beacon2) from the beacon 4 which is installed in the second area R2 via the communication unit 26. Then, the portable apparatus 2 transmits tracking data which includes a beacon ID reception time, the beacon ID, the user ID for identifying the user A and the enter flag (enter) to the server 1 via the communication unit 26. Then, when receiving the tracking data via the communication unit 16, the server 1 stores the tracking data into the logfile for the user A. In addition, the server 1 detects that the enter flag is included in the tracking data and thereby performs control in such a manner that a message M5 of such a content that “I'm photographing Mr. A (CAM2)” issued from the camerabot CB is displayed on the display unit 25 as illustrated in FIG. 6. Here, “CAM2” in the message M5 means the network camera 3 which is installed in the second area R2.

Next, as illustrated in FIG. 6, when a message M6 of such a content that “I'm tired” issued from the user A is displayed on the display unit 25 on the basis of the operation of the portable apparatus 2 by the user A, the message M6 is transmitted to the server 1 and the server 1 stores the message M6 and a message M6 transmission time into the logfile for the user A in correspondence with each other.

Next, as illustrated in FIG. 6, when a message M7 of such a content that “Terminate photographing” issued from the user A is displayed on the display unit 25 on the basis of the operation of the portable apparatus 2 by the user A, the message M7 is transmitted to the server 1 and the server 1 performs control in such a manner that a message M8 of such a content that “Photographing will be terminated” issued from the camerabot CB is displayed on the display unit 25. Then, the server 1 performs control in such a manner that a message M9 of such a content that “Now, edition is being done” issued from the camerabot CB is displayed on the display unit 25 and terminates recording of the tracking data and the messages into the logfile for the user A, and performs image edition processing on the basis of the image information stored in the image information DB 13c.

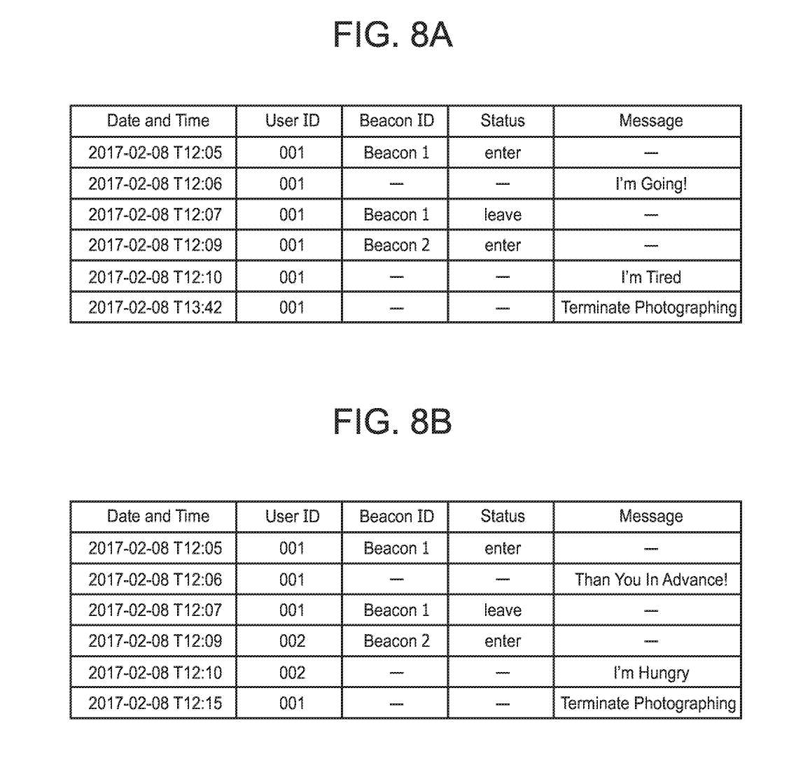

Specifically, the server 1 refers to the logfile for the user A illustrated in FIG. 8A and specifies parts (for example, images in periods that the user A enters the respective areas R1 to R3) relating to the user A from images in the image information stored in the image information DB 13c. Then, the server 1 cuts out the specified images, synthesizes the cut-out images in time series and generates one moving image. Incidentally, in a case where there is a message which is stored in the logfile for the user A in the periods that the user A enters the respective areas R1 to R3, the message may be reflected to the moving image and, for example, the message is run as a telop on the moving image.

Next, when the image edition processing is terminated, as illustrated in FIG. 6, the server 1 performs control in such a manner that a thumbnail image SG1 of the edited moving image is displayed on the display unit 25 together with a message M10 of such a content that “Here, it's done!” issued from the camerabot CB. Incidentally, the edited moving image may be made to be reproducible by touching the thumbnail image SG1 on the basis of the user operation.

Next, as illustrated in FIG. 6, when a message M11 of such a content that “I want to show it to everyone” issued from the user A is displayed on the display unit 25 on the basis of the operation of the portable apparatus 2 by the user A, the message M11 is transmitted to the server 1. The server 1 performs control in such a manner that a message M12 of such a content that “Published on a video sharing site? YES|NO” issued from the camerabot CB is displayed on the display unit 25. Then, when a message M13 of such a content that “YES” issued from the user A is displayed on the display unit 25 on the basis of the operation of the portable apparatus 2 by the user A, the message M13 is transmitted to the server 1 and the server 1 performs control in such a manner that a message M14 of such a content that “All right!” issued from the camerabot CB is displayed on the display unit 25. Then, the server 1 uploads the generated moving image on the video sharing site and performs control in such a manner that a message M15 indicating a public URL is displayed on the display unit 25.

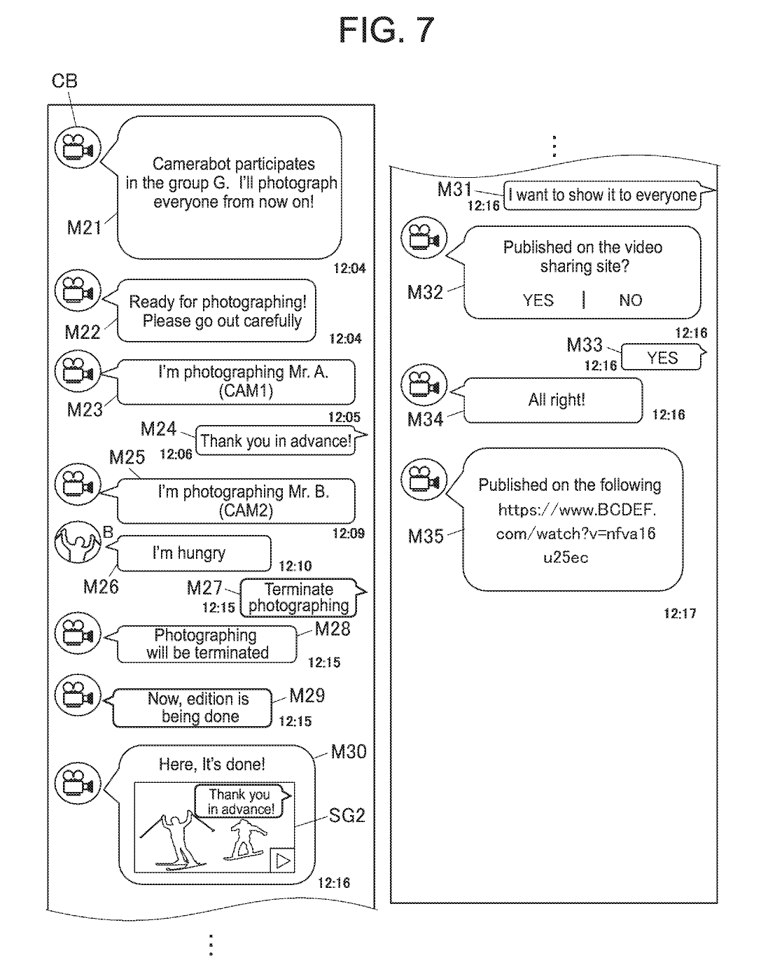

FIG. 7 is a diagram illustrating one example of a flow of conversations exchanged with the camerabot CB in a group chat. Here, description will be made in the following on the assumption that members who participate in the group chat are the user A and a user B who are illustrated in FIG. 5 and the name of this group is denoted as a group G. As illustrated in FIG. 7, for example, when the user A who intends to receive the group photographing service starts the chat function in the SNS site 6 via the portable apparatus 2 and registers the camerabot CB in the chat for the group G, the server 1 performs control in such a manner that a message M21 of such a content that “Camerabot participates in the group G. I'll photograph everyone from now own!” issued from the camerabot CB is displayed on the display units 25 of the portable apparatus 2 of the respective members (the user A and the user B). Then, when a logfile for the group G is prepared in the server 1, the server 1 performs control in such a manner that a message M22 of such a content that “Ready for photographing! Please go out carefully” issued from the camerabot CB is displayed on the display units 25.

Next, as illustrated in FIG. 5, when the user A starts sliding and enters the first area R1, the portable apparatus 2 that the user A possesses receives the beacon ID (=Beacon1) from the beacon 4 which is installed in the first area R1 via the communication unit 26. Then, the portable apparatus 2 transmits tracking data which includes a beacon ID reception time, the beacon ID, the user ID (=“001”) for identifying the user A and the enter flag to the server 1 via the communication unit 26. Then, when receiving the tracking data via the communication unit 16, the server 1 stores the tracking data into the logfile for the group G in the logfile DB 13b. In addition, the server 1 detects that the enter flag is included in the tracking data and thereby performs control in such a manner that a message M23 of such a content that “I'm photographing Mr. A (CAM1)” issued from the camerabot CB is displayed on the display units 25 as illustrated in FIG. 7.

Next, as illustrated in FIG. 7, when a message M24 of such a content that “Thank you in advance!” issued from the user A is displayed on the display units 25 on the basis of the operation of the portable apparatus 2 by the user A, the message M24 is transmitted to the server 1 and the server 1 stores the message M24 and a message M24 transmission time into the logfile for the group G in correspondence with each other.

Next, as illustrated in FIG. 5, when the user A leaves the first area R1 and reception of the beacon ID (=Beacon1) is interrupted for a definite period of time, the portable apparatus 2 transmits tracking data which includes a time that reception of the beacon ID was interrupted, the beacon ID, the user ID for identifying the user A and the leave flag to the server 1 via the communication unit 26. Then, when receiving this tracking data via the communication unit 16, the server 1 stores the tracking data into the logfile for the group G.

Next, as illustrated in FIG. 5, when the user B enters the second area R2, the portable apparatus 2 that the user B possesses receives the beacon ID (=Beacon2) from the beacon 4 which is installed in the second area R2 via the communication unit 26. Then, the portable apparatus 2 transmits tracking data which includes a beacon ID reception time, the beacon ID, a user ID (=“002”) for identifying the user B and the enter flag to the server 1 via the communication unit 26. Then, when receiving the tracking data via the communication unit 16, the server 1 stores the tracking data into the logfile for the group G. In addition, the server 1 detects that the enter flag is included in the tracking data and thereby performs control in such a manner that a message M25 of such a content that “I'm photographing Mr. B (CAM2)” issued from the camerabot CB is displayed on the display units 25 as illustrated in FIG. 7.

Next, as illustrated in FIG. 7, when a message M26 of such a content that “I'm hungry” issued from the user B is displayed on the display units 25 on the basis of the operation of the portable apparatus 2 by the user B, the message M26 is transmitted to the server 1 and the server 1 stores the message M26 and a message M26 transmission time into the logfile for the group G in correspondence with each other.

Next, as illustrated in FIG. 7, when a message M27 of such a content that “Terminate photographing” issued from the user A is displayed on the display units 25 on the basis of the operation of the portable apparatus 2 by the user A, the message M27 is transmitted to the server 1 and the server 1 performs control in such a manner that a message M28 of such a content that “Photographing will be terminated” issued from the camerabot CB is displayed on the display units 25. Then, the server 1 performs control in such a manner that a message M29 of such a content that “Now, edition is being done” issued from the camerabot CB is displayed on the display units 25, terminates recording of the tracking data and the messages into the logfile for the group G and performs the image edition processing on the basis of the image information stored in the image information DB 13c.

Specifically, the server 1 refers to the logfile for the group G illustrated in FIG. 8B and specifies parts (for example, images in periods that the user A and the user B enter the respective areas R1 to R3 respectively) relating to the user A and the user B from images in the image information stored in the image information DB 13c. Then, the server 1 cuts out the specified images, synthesizes the cut-out images in time series and generates one moving image. Incidentally, in a case where there is a message which is stored into the logfile for the group G in the periods that the user A and the user B enter the respective areas R1 to R3 respectively, the message may be reflected to the moving message and, for example, the message is run as the telop on the moving image.

Next, when the image edition processing is terminated, as illustrated in FIG. 7, the server 1 performs control in such a manner that a thumbnail image SG2 of the edited moving image is displayed on the display units 25 together with a message M30 of such a content that “Here, it's done!” issued from the camerabot CB. Incidentally, the edited moving image may be made to be reproducible by touching the thumbnail image SG2 on the basis of the user operation.

Next, as illustrated in FIG. 7, when a message M31 of such a content that “I want to show it to everyone” issued from the user A is displayed on the display units 25 on the basis of the operation of the portable apparatus 2 by the user A, the message M31 is transmitted to the server 1. The server 1 performs control in such a manner that a message M32 of such a content that “Published on the video sharing site? YES|NO” issued from the camerabot CB is displayed on the display units 25. Then, when a message M33 of such a content that “YES” issued from the user A is displayed on the display units 25 on the basis of the operation of the portable apparatus 2 by the user A, the message M33 is transmitted to the server 1 and the server 1 performs control in such a manner that a message M34 of such a content that “All right!” issued from the camerabot CB is displayed on the display units 25. Then, the server 1 uploads the generated moving image on the video sharing site and performs control in such a manner that a message M35 indicating a public URL is displayed on the display units 25.

Next, control procedures of the image edition processing of the server 1 in the photographing system 100 will be described.

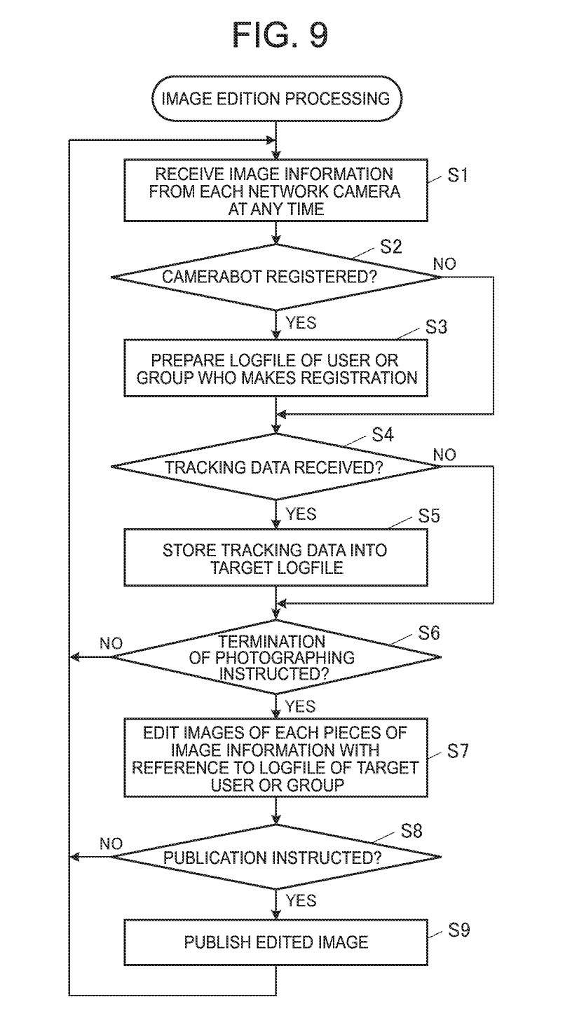

FIG. 9 is a flowchart illustrating one example of the control procedures of the image edition processing.

As illustrated in FIG. 9, when the image edition processing is started, the PROCESSOR 11 of the server 1 receives image information from the network cameras 3 which are installed in the first to third areas R1 to R3 (see FIG. 5) via the communication unit 16 at any time (step S1) and stores the image information concerned into the image information DB 13c.

Next, the PROCESSOR 11 decides whether registration of the camerabot CB is made by the portable apparatus 2 via the SNS site 6 (step S2).

In step S2, in a case where it is decided that registration of the camerabot CB is made by the portable apparatus 2 (step S2: YES), the PROCESSOR 11 prepares a logfile for a user or a group who makes registration of the camerabot CB, stores the logfile into the logfile DB 13b (step S3) and shifts to a process of step S2.

On the other hand, in step S2, in a case where it is decided that registration of the camerabot CB is not made by the portable apparatus 2 (step S2: NO), the PROCESSOR 11 skips over step S3 and shifts to a process of step S4.

Next, the PROCESSOR 11 decides whether tracking data is received from the portable apparatus 2 via the communication unit 16 (step S4).

In step S4, in a case where it is decided that the tracking data is received from the portable apparatus 2 (step S4: YES), the PROCESSOR 11 stores the received tracking data into the logfile for the target user or group (step S5) and shifts to a process of step S6.

On the other hand, in step S4, in a case where it is decided that the tracking data is not received from the portable apparatus 2 (step S4: NO), the PROCESSOR 11 skips over step S5 and shifts to a process of step S6.

Next, the PROCESSOR 11 decides whether termination gf photographing is instructed from the portable apparatus 2 via the SNS site 6 (step S6).

In step S6, in a case where it is decided that the termination of photographing is not instructed from the portable apparatus 2 (step S6: NO), the PROCESSOR 11 returns the process back to step S1 and executes the subsequent processes repetitively.

On the other hand, in step S6, in a case where it is decided that the termination of photographing is instructed from the portable apparatus 2 (step S6: YES), the PROCESSOR 11 refers to the logfile for the target user or group and edits the images in the respective pieces of image information which are stored in the image information DB 13c (step S7). Specifically, the PROCESSOR 11 specifies images of parts relating to the target user or group from the images in the respective pieces of image information which are stored in the image information DB 13c. Then, the PROCESSOR 11 cuts out the specified images, synthesizes the cut-out images in time series and generates one moving image.

Next, the processor 11 decides whether publication of the moving image is instructed from the portable apparatus 2 via the SNS site 6 (step S8).

In step S8, in a case where it is decided that the publication of the moving image is not instructed from the portable apparatus 2 (step S8: NO), the PROCESSOR 11 returns the process back to the step S1 and executes the subsequent processes repetitively.

On the other hand, in step S8, in a case where it is decided that the publication of the moving image is instructed from the portable apparatus 2 (step S8: YES), the PROCESSOR 11 publishes the moving image which is edited in step S7 on a video sharing site (step S9), returns the process back to step S1 and executes the subsequent processes repetitively. Incidentally, the PROCESSOR 11 executes the processes of step S1 to step S9 repetitively while the power source of the server 1 is in an ON state.

In addition, although in the above-described embodiment, the tracking data (the enter and leave time information) relating to the enter and leave times of the object is generated, tracking data (enter and leave date and time information) relating to enter and leave dates and times of the object may be generated. According to the photographing system 100 of the present embodiment, the network camera 3 transmits the image information pertaining to the image which is captured by the network camera 3 concerned, the beacon 4 transmits the beacon ID and the portable apparatus 2 receives the beacon ID, generates the tracking data (the enter and leave time information) relating to the times that the object enters and leaves the area where the beacon 4 which corresponds to the beacon ID concerned is installed on the basis of the reception status of the beacon ID and transmits the generated tracking data. The server 1 receives the image information which is transmitted from the network camera 3 and the tracking data which is transmitted from the portable apparatus 2 and consequently specifies the images of the parts relating to the enter and leave times of the object from the images in the image information concerned on the basis of the image information concerned and the tracking data concerned.

Therefore, since the server 1 is able to specify the images of the parts relating to the enter and leave times of the object concerned from the images in the image information which is transmitted from the network camera 3 simply by transmitting the tracking data from the portable apparatus 2 that the object possesses to the server 1, it becomes possible to accurately catch the object concerned by efficient processing using the portable apparatus 2 concerned.

In addition, according to the photographing system 100 of the present embodiment, a plurality of the network cameras 3 and a plurality of the beacons 4 are provided respectively, each network camera 3 and each beacon 4 are installed in each of the plurality of areas (the first area R1, the second area R2 and the third area R3) and each network camera 3 transmits the image information pertaining to the image which is captured by the network camera 3 concerned and the beacon ID of the beacon 4 which is installed in the same area as that of the network camera 3 concerned in correspondence with each other. The server 1 receives the image information and the beacon ID which is made in correspondence with the image information which are transmitted from each network camera 3 and the tracking data which is transmitted from the portable apparatus 2 and consequently specifies the images of the parts relating to the enter and leave times of the project from the images in the image information concerned for every piece of the image information on the basis of the image information concerned and the beacon ID which is made in correspondence with the image information concerned, and the tracking data concerned.

Accordingly, since it is possible to specify the images of the parts relating to the enter and leave times of the object from the images which are photographed in the respective areas, it becomes possible to utilize the photographing system 100 diversely.

In addition, according to the photographing system 100 of the present embodiment, a plurality of the portable apparatus 2 is provided, each of the plurality of objects possesses each of the portable apparatus 2, each network camera 3 transmits the image information pertaining to the image which is captured by the network camera 3 concerned and the beacon ID of the beacon 4 which is installed in the same area as that of the network camera 3 in correspondence with each other and each portable apparatus 2 transmits the tracking data and the user ID in correspondence with each other. The server 1 receives the image information and the beacon ID which is made in correspondence with the image information which are transmitted from each network camera 3, and the tracking data and the user ID which are transmitted from each portable apparatus 2 and consequently specifies images of parts relating to enter and leave times of an object who corresponds to the user ID concerned from the images in the image information concerned for every piece of the image information on the basis of the image information concerned and the beacon ID which is made in correspondence with the image information, and the tracking data concerned and the user ID.

Accordingly, it is possible to specify the images of the parts relating to the respective enter and leave times of the plurality of objects, it becomes possible to utilize the photographing system 100 more diversely.

In addition, according to the photographing system 100 of the present embodiment, the server 1 generates the logfile (the related information) indicating the relation between the image information and the beacon ID which is made in correspondence with the image information concerned, and the tracking data and the user ID which are transmitted from the portable apparatus 2 concerned, stores the logfile concerned into the logfile DB 13b and consequently specifies images of parts relating to enter and leave times of a desirable object who corresponds to the user ID from the images in the image information concerned for every piece of the image information on the basis of the logfile which is stored in the logfile DB 13b.

Accordingly, since it is possible to specify the images of the parts relating to the enter and leave times of the object of the desirable user ID on the basis of the logfile which is stored in advance in the logfile DB 13b, it becomes possible to perform specification of the images concerned smoothly.

In addition, according to the photographing system 100 of the present embodiment, the server 1 cuts out and synthesizes the plurality of the specified images consequently. Therefore, since it is possible to see the plurality of specified images altogether at one time, it becomes possible to facilitate confirmation of the image.

In addition, according to the photographing system 100 of the present embodiment, the portable apparatus 2 further transmits the input information which is input on the basis of the user operation of the portable apparatus 2 concerned. The server 1 receives the input information which is transmitted from the portable apparatus 2 and consequently further synthesizes the input information concerned when synthesizing the plurality of cut-out images. Therefore, since it becomes possible to add a message and so forth to the images to be synthesized, it is possible to edit the images into a synthetic image which is peculiar to each user.

In addition, according to the photographing system 100 of the present embodiment, when synthesizing the plurality of cut-out images, the server 1 synthesizes the plurality of cut-out images concerned in order of the times that the tracking data indicates. Therefore, it becomes possible to confirm the state of the object which changes with time.

In addition, according to the photographing system 100 of the present embodiment, when synthesis of the plurality of cut-out images is terminated, the server 1 transmits termination notice information which indicates that the synthesis concerned is terminated to the portable apparatus 2. Therefore, it becomes possible to promptly confirm the synthetic image so synthesized.

In addition, according to the photographing system 100 of the present embodiment, the server 1 is able to upload the synthetic image so synthesized onto the video sharing site. Therefore, it is possible to share the synthetic image with other users.

Incidentally, the present invention is not limited to the above-described embodiment and various improvements and design alterations may be made within a range not deviating from the gist of the present invention.

For example, although in the above-described embodiment, description was made by illustrating a case where the photographing system 100 is used in the skiing ground, a place where the photographing system 100 is used may be a region where movement of the object is assumed and, for example, may be a theme park, a marathon course and so forth. In addition, in regard to the network camera 3 and the beacon 4 used in the photographing system 100, for example, the network camera 3 and the beacon 4 may be combined with each other and installed on a moving body (for example, an attraction) in the theme park, not limited to a case where the network camera 3 and the beacon 4 are installed in the predetermined area.

In addition, although in the above-described embodiment, edition of the image and uploading of the edited image are performed in the server 1, for example, re-edition such as insertion of a title, a telop and so forth into the edited image, change of the title, the telop and so forth in the edited image, cutting of an unnecessary scene and so forth may be performed on the basis of the user operation.

In addition, although in the above-described embodiment, the user A gives the instructions to terminate photographing and to publish the moving image in the respective users (the user A and the user B) who receive provision of the group photographing service, for example, only a user (for example, an administrator) for whom setting is made in advance may give the instructions to terminate photographing and to publish the moving image in the plurality of users who compose the group.

In addition, although in the above-described embodiment, the server 1 cuts the images of the parts relating to the target user or group out of the respective pieces of the image information stored in the image information DB 13c, synthesizes the cut-out images in time series and generates one moving image, for example, the moving image may be generated by synthesizing each cut-out image to each area where photographing is performed.

In addition, although in the above-described embodiment, the network camera 3 and the beacon 4 are installed in each of the respective areas (the first area R1, the second area R2 and the third area R3), for example, the network camera 3 and the beacon 4 may be integrated into one device and the device so integrated may be installed in each area.

Although the embodiment of the present invention was described as above, the scope of the present invention is not limited to the above-described embodiment and embraces the scope of the invention described in the appended claims and a range of equivalency of the claims.

What is claimed is:

1. An image processing system comprising:
a portable apparatus that an object possesses;
an imaging device which is installed in a predetermined area;
a transmission device which is installed in the predetermined area and transmits a transmission device ID which identifies the transmission device itself;
an image processing device which processes an image which is captured by the imaging device, wherein
a PROCESSOR of the imaging device transmits image information pertaining to the image which is captured by the imaging device,
a PROCESSOR of the transmission device transmits the transmission device ID,
a PROCESSOR of the portable apparatus
receives the transmitted transmission device ID,
generates information which corresponds to the transmission device ID on the basis of a reception status of the transmission device ID and
transmits the generated information which corresponds to the transmission device ID or the transmission device ID, and
a PROCESSOR of the image processing device
receives the transmitted image information and the transmitted information which corresponds to the transmission device ID or the transmission device ID and
specifies images of parts relating to times that the object enters and leaves the area where the transmission device is installed from images in the image information on the basis of the received image information and the received information which corresponds to the transmission device ID or the received transmission device ID.

2. The image processing system according to claim 1, wherein
a plurality of the imaging devices and a plurality of the transmission devices are provided respectively,
each of the imaging devices and each of the transmission devices are installed in each of a plurality of areas,
the PROCESSOR of the imaging device transmits the image information pertaining to the image which is captured by the imaging device and the transmission device ID of the transmission device which is installed in the area which is the same as the area of the imaging device in correspondence with each other, and
the PROCESSOR of the image processing device receives the transmitted image information and the transmitted transmission device ID which is made in correspondence with the image information, and the information which is transmitted from a transmission section on the portable apparatus side and corresponds to the transmission device ID, and
specifies the images of the parts relating to the enter and leave times of the object from the images in the image information for every piece of the image information on the basis of the image information which is received by a reception section on the image processing device side and the transmission device ID which is received by the reception section on the image processing device side and is made in correspondence with the image information, and the transmitted information which corresponds to the transmission device ID.

3. The image processing system according to claim 1, wherein
a plurality of the portable apparatus is provided,
each of a plurality of the objects possesses each of the portable apparatus,
the PROCESSOR of the imaging device transmits the image information pertaining to the image which is captured by the imaging device and the transmission device ID of the transmission device which is installed in the area which is the same as the area of the imaging device in correspondence with each other,
the PROCESSOR of the portable apparatus transmits the generated information which corresponds to the transmission device ID or the transmission device ID and a user ID of the object in correspondence with each other,
the PROCESSOR of the image processing device receives the transmitted image information and the transmitted transmission ID which is made in correspondence with the image information, and the transmitted information which corresponds to the transmission device ID and the transmitted user ID and
specifies images of parts relating to enter and leave times of an object who corresponds to the user ID from the images in the image information for every piece of the image information on the basis of the received image information and the received transmission device ID which is made in correspondence with the image information, and the transmitted information which corresponds to the transmission device ID and the transmitted user ID.

4. The image processing system according to claim 3, wherein
the PROCESSOR of the image processing device
generates related information indicating a relation between the received image information and the received transmission device ID which is made in correspondence with the image information, and the information which is transmitted from a transmission section on the portable apparatus side and corresponds to the transmission device ID or the transmission device ID and the user ID which is transmitted from the transmission section on the portable apparatus side,
makes a storage unit store the generated related information, and
specifies images of parts relating to enter and leave times of a desirable object who corresponds to the user ID from the images in the image information for every piece of the image information on the basis of the stored related information.

5. The image processing system according to claim 1, wherein
the PROCESSOR of the image processing device cuts out the specified image.

6. The image processing system according to claim 5, wherein
the PROCESSOR of the image processing device synthesizes a plurality of the cut-out images.

7. The image processing system according to claim 6, wherein
the PROCESSOR of the portable apparatus further transmits input information which is input on the basis of a user operation of the portable apparatus and
the PROCESSOR of the image processing device receives the transmitted input information and
further synthesizes the received input information when synthesizing the plurality of cut-out images.

8. The image processing system according to claim 6, wherein
an image synthesis section synthesizes the plurality of images in time series when synthesizing the plurality of images which is cut out by an image cut-out section.

9. The image processing system according to claim 6, wherein
an image synthesis section synthesizes the plurality of images for every area where the imaging device is installed when synthesizing the plurality of images which is cut out by an image cut-out section.

10. The image processing system according to claim 6, wherein
the image processing device further includes an image processing device side transmission section which transmits termination notice information indicating that the synthesis is terminated to the portable apparatus when synthesis of the plurality of images by an image synthesis section is terminated.

11. The image processing system according to claim 6, wherein
the PROCESSOR of the image processing device uploads a synthetic image so synthesized onto an image sharing site.

12. An image processing method by an image processing system including
a portable apparatus that an object possesses,
an imaging device which is installed in a predetermined area,
a transmission device which is installed in the predetermined area and transmits a transmission device ID which identifies the transmission device itself, and
an image processing device which processes an image which is captured by the imaging device, comprising:
the step of transmitting, by the imaging device, image information pertaining to the image which is captured by the imaging device;
the step of transmitting the transmission device ID by the transmission device;
the step of receiving the transmission device ID which is transmitted from the transmission device, generating information which corresponds to the transmission device ID on the basis of a reception status of the transmission device ID and transmitting the generated information which corresponds to the transmission device ID or the transmission device ID by the portable apparatus; and
the step of receiving the image information which is transmitted from the imaging device and the information which is transmitted from the portable apparatus and corresponds to the transmission device ID or the transmission device ID and specifying images of parts relating to times that the object enters and leaves the area where the transmission device is installed from images in the image information on the basis of the image information and the information which corresponds to the transmission device ID or the transmission device ID.

13. An image processing device which processes an image which is captured by an imaging device, wherein
a PROCESSOR of the image processing device
receives image information of the image which is captured by the imaging device which is installed in a predetermined area,
receives information which is generated by a portable apparatus that an object possesses on the basis of a reception status of a transmission device ID of a transmission device which is installed in the predetermined area and which corresponds to the transmission device ID or the transmission device ID, and
specifies images of parts relating to times that the object enters and leaves the area where the transmission device is installed from images in the image information on the basis of the received image information and the received information which corresponds to the transmission device ID or the transmission device ID.

14. A recording medium in which a computer readable program is recorded, making a computer implement:
a first reception function of receiving image information of an image which is captured by the imaging device which is installed in a predetermined area;
a second reception function of receiving information which is generated by a portable apparatus that an object possesses on the basis of a reception status of a transmission device ID of a transmission device which is installed in the predetermined area and corresponds to the transmission device ID or the transmission device ID; and
an image specification function of specifying images of parts relating to times that the object enters and leaves the area where the transmission device is installed from images in the image information on the basis of the image information which is received by the first reception function and the information which is received by the second reception function and corresponds to the transmission device ID or the transmission device ID.

15. A portable apparatus that an object possesses, wherein
a PROCESSOR of the portable apparatus
receives a transmission device ID which is transmitted from a transmission device which is installed in a predetermined area and transmits the transmission device ID for identifying the transmission device itself,
generates information which corresponds to the transmission device ID on the basis of a reception status of the transmission device ID,
transmits the generated information or the transmission device ID to an image processing device and
acquires images of parts relating to times that the object enters and leaves the predetermined area which is specified by the image processing device on the basis of an image which is captured by an imaging device which is installed in the predetermined area and the information which corresponds to the transmission device ID or the transmission device ID.

16. The portable apparatus according to claim 15, wherein
the PROCESSOR of the portable apparatus generates the information which corresponds to the transmission device ID at a timing of receiving the transmission device ID.

17. The portable apparatus according to claim 15, wherein
the PROCESSOR of the portable apparatus generates enter and leave time information relating to the times that the object enters and leaves the area where the transmission device which corresponds to the transmission ID is installed as the information which corresponds to the transmission device ID.
